(19) United States
(12) Patent Application Publication
(10) Pub. No.: US 2006/0119705 A1
(43) Pub. Date: Jun. 8, 2006

(54) Apparatus for creating effectively transparent A-pillars on vehicle

(75) Inventor: Chungpin Liao, Taichung (TW)

Correspondence Address: BIRCH STEWART KOLASCH & BIRCH, PO BOX 747, FALLS CHURCH, VA, 22040-0747, US

(73) Assignee: ARBL CO., LTD.

(21) Appl. No.: 11/293,250

(22) Filed: Dec. 5, 2005

(30) Foreign Application Priority Data
Dec. 6, 2004 (TW) 093137570

(51) Int. Cl. H04N 7/18; H04N 9/47

(52) U.S. Cl. 348/148

(57) ABSTRACT

An apparatus to enhance driving safety for vehicles especially in the dynamic conditions at turning includes a display panel installed on an inner side of the vehicle A-pillar and a video camera installed on an outer side of the A-pillar. Vision outside the A-pillar can be dynamically captured by the video camera and displayed on the display panel. Hence the visual scope of the driver increases. A video camera array can be provided to capture the images of different angles. And an image processor is provided to process the images and display a full scope image on a full scope display panel on the inner side of the A-pillar. Thereby the driver can get a visual image equivalent to a transparent A-pillar to enhance driving safety.

### FIELD OF THE INVENTION

The present invention relates to a safety apparatus for vehicle and particularly to an apparatus to produce a transparent-like effect on A-pillars of vehicle to facilitate drivers with unhindered visual sight at side angles for enhanced driving safety.

### BACKGROUND OF THE INVENTION

A car's A-pillars are formed as part of the vehicle body and are normally opaque. Abundance of evidence shows that many car driving accidents were in fact caused by the blinding effect of these opaque A-pillars on two sides of the cars' windshields. Especially while the vehicle is making a turn, if a motorcycle nearby is also making a similar move, with an angular frequency close to that of the vehicle though at a lower speed, the car driver's vision of the motorcycle may be temporarily blocked by one of his own A-pillars and an accident will likely happen within a fairly short period of time. Thus, very often, it is only after an impact has occurred then the car driver become aware of the presence of the motorcycle.

Reasonably, the width of A-pillars should be an important concern for consumers buying their vehicle. To this end, a smaller A-pillar width is generally a preferable choice. It would have been much better had those A-pillars been routinely made of transparent materials. However, there are other structural concerns other than the mere fact that the A-pillars are supposed to support the top of vehicle. More importantly, A-pillars have to be strong enough to bear the rolling impact and prevent the interior vehicle space from being crushed, in the event that accident occurs and the vehicle rolls over. Hence, the option for A-pillar materials is very limited. To fabricate A-pillars using transparent materials faces many problems arising from the sides of structural technology, structural safety and cost that are difficult to overcome.

Still, under the strong demand of drivers, some car manufacturers (such as Saab) have managed to move the A-pillars further side-wards to make the windshield (or, visual range) wider. While such an approach can reduce the vision hindrance of the drivers, its unusual design and manufacturing to meet the structural strength requirements have obviously raised the vehicle's cost considerably.

### SUMMARY OF THE INVENTION

The primary object of the present invention is to provide an apparatus to enhance vehicle safety by giving drivers a visual image originally blocked by A-pillars of the vehicle when driving.

Another object of the present invention is to provide drivers a visual image equivalent to a transparent A-pillar.

To achieve the foregoing objects, the present invention includes a video camera and a display panel. The video camera is installed on an outer side of the A-pillar of a vehicle. The display panel is installed on an inner side of the A-pillar to receive image signals from the video camera and display the images captured by the video camera. Thereby drivers can see the visual images blocked by the A-pillar on the display panel.

The invention further has an image processor. A full scope display panel is installed on the inner side of the A-pillar of the vehicle, and a video camera array is installed on the outer side of the A-pillar to capture images of different angles. The image signals are transferred to the image processor and are integrated and displayed on the full scope display panel so that the driver can get a visual image equivalent of a transparent A-pillar to enhance driving safety.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the present invention installed on a vehicle A-pillar.

FIG. 2 is a side view of a vehicle A-pillar according to the present invention.

FIG. 3 is a schematic view of another embodiment of the present invention.

FIG. 4 is a side view of another embodiment of the vehicle A-pillar of the present invention.

FIG. 5 is a functional block diagram of another embodiment of the present invention.

### DETAILED DESCRIPTION OF THE PREFERRED EMBODIMENTS

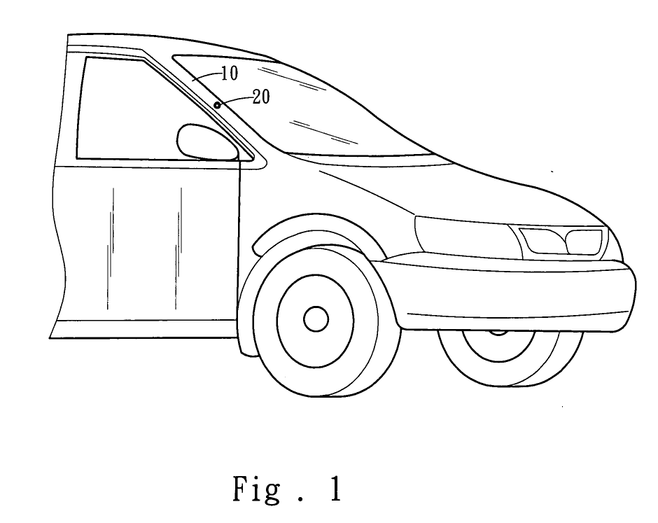

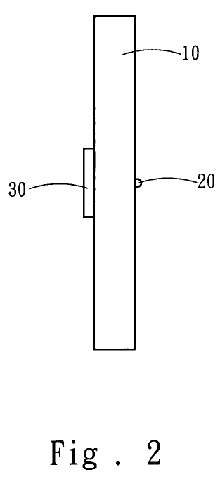

Please refer to FIGS. 1 and 2 for the apparatus of the present invention that enables a vehicle A-pillar 10 to have a transparent-like effect. The vehicle A-pillar 10 has a video camera 20 installed on an outer side and a display panel 30 installed on an inner side. The display panel 30 can receive image signals from the video camera 20 and display the captured images.

The display panel 30 may be selected from liquid crystal display (LCD), light emitting diode (LED) or organic LED (OLED). The video camera 20 is a pin-hole video camera which captures images and sends image signals via a wireless or wired transmission method to the display panel 30. The captured images can be instantly displayed on the display panel 30. Thereby the driver can see the images blocked by the A-pillar 10 to enhance driving safety.

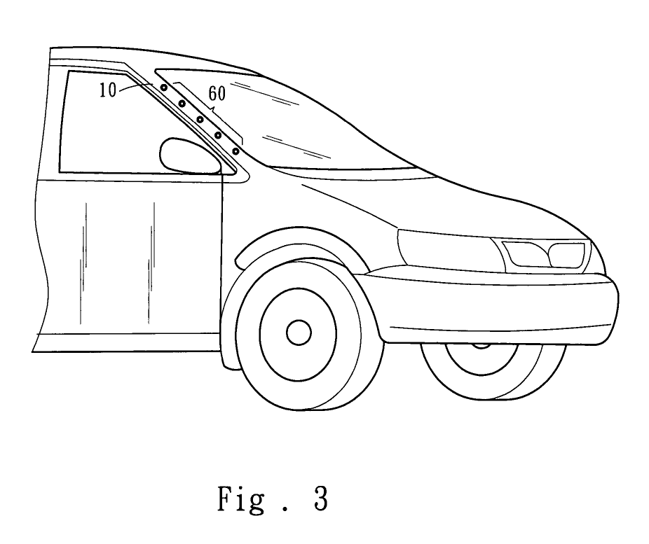

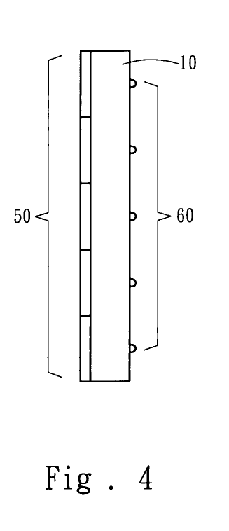

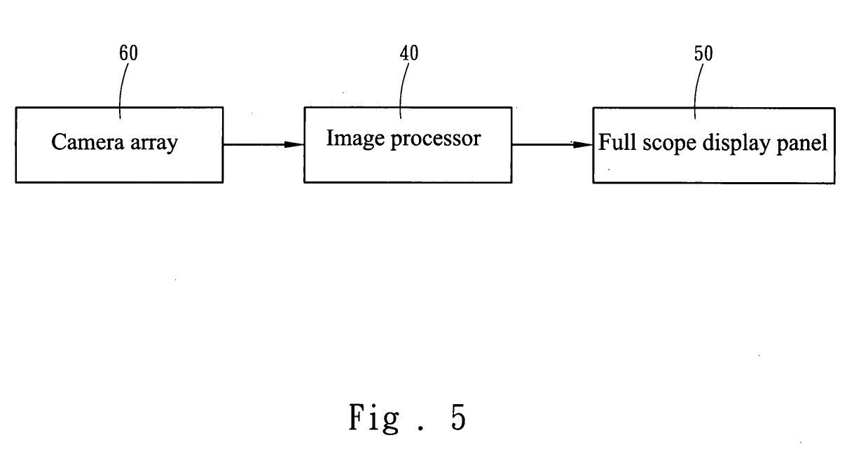

Refer to FIGS. 3, 4 and 5 for a second embodiment of the present invention. It further has an image processor 40. The vehicle A-pillar 10 has a full scope display panel 50 on the inner side that covers the entire inner surface of the A-pillar 10. It may be formed by coupling a plurality of panels in a close and juxtaposed manner. The vehicle A-pillar 10 has a video camera array 60 on the outer side that consists of a plurality of independent video cameras 20 to capture the images of different angles simultaneously.

The full scope display panel 50 may also be selected from LCD, LED or OLED. The video camera array 60 consists of a plurality of pin-hole video cameras to send image signals via a wireless transmission method to the image processor 40. The image signals of different angles captured by the video camera array 60 (some of them are overlapped) are processed and integrated by the image processor 40 to become a complete image, and sent to the full scope display panel 50 for displaying. Thereby the driver can see the entire image blocked by the A-pillar 10. As far as the driver is concern, the A-pillar 10 likes transparent. Hence the driver can get a visual image equivalent to a transparent A-pillar 10.

As previously discussed, with the aid of the video camera 20 and display panel 30 of the present invention, and under the condition of without altering the vehicle structure, the driver can see the images blocked by the A-pillar 10. Through the video camera array 60 and full scope display panel 50, and the image processor 40 to process, integrate and output the images of different angles captured by the video camera array 60, the driver can get a visual image on the full scope display panel 50 equivalent to a transparent A-pillar. Thus driving safety of the vehicle can be greatly enhanced.

While the invention has been particularly shown and described with reference to the preferred embodiments thereof, it will be understood by those skilled in the art that various changes in form and details may be made without departing from the spirit and scope of the inventions such as making an A-pillar effectively transparent only on some portion of the length of the A-pillar, or only on some portion of the width of the A-pillar. Others like partitioning the display region into several parts, and even orientating them in any fashion.

What is claimed is:

1. An apparatus to produce a transparent-equivalent effect for vehicle A-pillar installed on a vehicle A-pillar, comprising:
a video camera installed on an outer side of the vehicle A-pillar and a display panel installed on an inner side of the vehicle A-pillar to receive image signals from the video camera and display images captured by the video camera.

2. The apparatus of claim 1 further having an image processor, the display panel being a full scope display panel, the video camera being a camera array to dynamically capture the images of different angles, the image signals being transferred to the image processor and integrated to be displayed on the full scope display panel.

3. The apparatus of claim 2, wherein the full scope display panel is selected from the group consisting of a liquid crystal display (LCD), a light emitting diode (LED) and an organic LED (OLED).

4. The apparatus of claim 2, wherein the video camera array includes a plurality of pin-hole video cameras.

5. The apparatus of claim 1, wherein the display panel is selected from the group consisting of a liquid crystal display (LCD), a light emitting diode (LED) and an organic LED (OLED).

6. The apparatus of claim 1, wherein the video camera is a pin-hole video camera.

7. The apparatus of claim 1, wherein the video camera transfers the image signals to the display panel via a wireless method.

8. The apparatus of claim 1, wherein the video camera transfers the image signals to the display panel via a wired method.
